(19) United States
(12) Patent Application Publication
(10) Pub. No.: US 2025/0111523 A1
(43) Pub. Date: Apr. 3, 2025

(54) Video Object Detection Using Motion Cues From Frame Differencing

(71) Applicant: United States of America as represented by the Secretary of the Navy, San Diego, CA (US)

(72) Inventors: Shibin Parameswaran, San Diego, CA (US); Lena Marie Nans, San Diego, CA (US); Chelsea Maine Mediavilla, San Diego, CA (US); Diego Marez, Oceanside, CA (US)

(21) Appl. No.: 18/476,722

(22) Filed: Sep. 28, 2023

(51) Int. Cl. G06T 7/254; G06T 5/00; G06T 5/20; G06T 5/50; G06V 10/82; G06V 20/17; G06V 20/40

(52) U.S. Cl. CPC G06T 7/254; G06T 5/20; G06T 5/50; G06T 5/70; G06V 10/82; G06V 20/17; G06V 20/46; G06T 2207/10016; G06T 2207/10032; G06T 2207/20081; G06T 2207/20084; G06T 2207/20192; G06T 2207/20224; G06V 2201/10

(57) ABSTRACT

A method for detecting objects in a video comprising: selecting an initial image frame m from the video, wherein the initial image frame m is preceded by a previous image frame m-p and followed by a subsequent image frame m+n; creating a first difference image by subtracting the subsequent image frame m+n from the initial image frame m; creating a second difference image by subtracting the initial image frame m from the previous image frame m−p; combining the first and second difference images to create a resulting image; concatenating the resulting image and the initial image frame m to create a concatenated input; and feeding the concatenated input into an object detection network configured to leverage motion-cue side information contained in the resulting image and the initial image frame m to facilitate rapid detection of moving objects in the video.

### FEDERALLY-SPONSORED RESEARCH AND DEVELOPMENT

The United States Government has ownership rights in this invention. Licensing and technical inquiries may be directed to the Office of Research and Technical Applications, Naval Information Warfare Center Pacific, Code 72120, San Diego, CA, 92152; voice (619) 553-5118; NIWC_Pacific_T2@us.navy.mil. Reference Navy Case Number 211228.

### BACKGROUND OF THE INVENTION

This invention relates to the field of computer vision object detection. Deep neural networks have been used in the past to detect and count moving objects in images recorded from stationary cameras. Typically, training deep neural networks requires a diverse array of single images to learn convolutional filters. This variety in data helps to build more robust detectors that can adapt to new test scenes; and, weights from these networks can be used to initialize models. At the same time, many cases in object detection involve detecting objects in videos. When broken down into individual frames, video images tend to be more homogeneous as a dataset. Most object detectors detect objects in a single frame without any consideration for the continuity of the video. This approach of performing detection on a frame-by-frame basis is rooted in the desire to minimize computation during detection. There is a need for an improved object detection method in video feeds.

### SUMMARY

Disclosed herein is a method for detecting objects in a video, an embodiment of which comprises the following steps. The first step provides for selecting an initial image frame m from the video. The initial image frame m is preceded by a previous image frame m-p and followed by a subsequent image frame m+n, where n and p represent a number of frames. Another step provides for creating a first difference image by subtracting the subsequent image frame m+n from the initial image frame m. Another step provides for creating a second difference image by subtracting the initial image frame m from the previous image frame m-p. Another step provides for combining the first and second difference images to create a resulting image. Another step provides for concatenating the resulting image and the initial image frame m to create a concatenated input. Another step provides for feeding the concatenated input into an object detection network configured to detect moving objects. The object detection network is configured to leverage motion-cue side information contained in the resulting image and the initial image frame m to facilitate rapid detection of moving objects in the video.

Another embodiment of the method for detecting objects in a video is also disclosed as comprising the following steps. The first step provides for parsing the video into frames. The next step provides for selecting one in every predetermined quantity of frames as a key frame of interest m. The next step provides for calculating the absolute difference between a given key frame of interest mₜ at time t and a preceding frame mₜ₋ₓ according to abs (mₜ−mₜ₋ₓ) to create a first difference image, where x is a predetermined amount of time. The next step provides for calculating the absolute difference between the given key frame of interest mₜ and a subsequent frame mₜ₊ₓ according to abs (mₜ mₜ₊ₓ) to create a second difference image. It is be understood that the time period x between the key frame of interest (i.e., the initial frame) and the preceding and subsequent frames need not be the same amount of time. The next step provides for performing a bitwise OR function on the first and second difference images to create a first resulting image. The next step provides for feeding the first resulting image and the given key frame of interest mₜ into a deep neural network configured to detect moving objects in the video.

The method for detecting objects in a video is described in another embodiment as comprising the following steps. The first step provides for extracting motion information from the video by subtracting a frame of interest from its adjacent frames to create two initial difference images. The next step provides for using one or more of a bitwise-AND function and a bitwise-OR function to create a resulting image from the two initial difference images. The resulting image retains past and future motion information relative to the frame of interest. Another step provides for concatenating the resulting image onto the frame of interest. Another step provides for feeding the concatenated images into a deep neural network configured to identify moving objects in the frame of interest.

### BRIEF DESCRIPTION OF THE DRAWINGS

Throughout the several views, like elements are referenced using like references. The elements in the figures are not drawn to scale and some dimensions are exaggerated for clarity.

FIG. 1 is a flowchart of a method for detecting objects in video.

FIG. 2 is a visual representation of an embodiment of a method for detecting objects in video.

FIG. 3 is a visual representation of an embodiment of a method for detecting objects in video.

### DETAILED DESCRIPTION OF EMBODIMENTS

The method disclosed below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically.

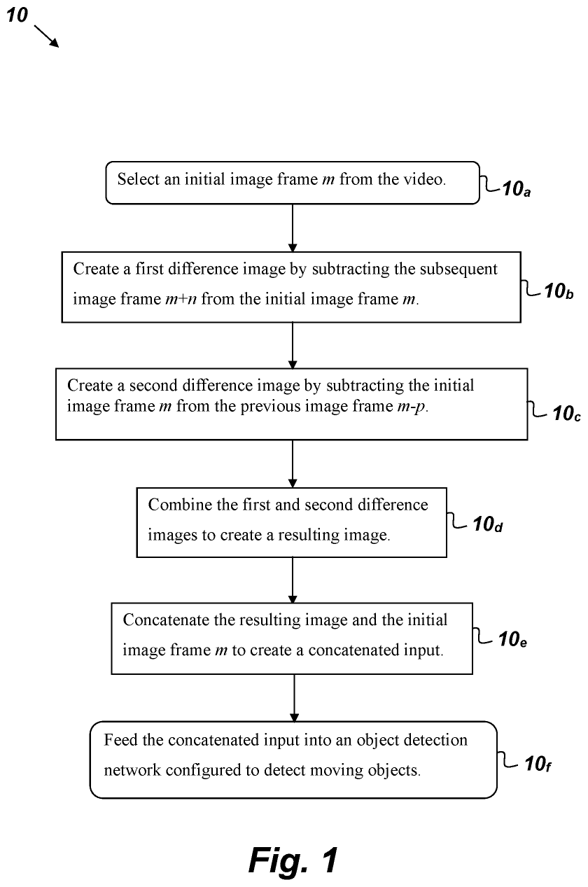

FIG. 1 is a flowchart of a method 10 for detecting objects in video that comprises, consists of, or consists essentially of the following steps. The first step 10ₐ provides for selecting an initial image frame m from the video. The initial image frame m is preceded by a previous image frame m-p and followed by a subsequent image frame m+n, where p and n each represent a number of frames. The variables p and n may or may not be equal to each other. Another step 10_{b} provides for creating a first difference image by subtracting the subsequent image frame mtn from the initial image frame m. Another step 10_{c} provides for creating a second difference image by subtracting the initial image frame m from the previous image frame m-p. Another step 10_{d} provides for combining the first and second difference images to create a resulting image. Another step 10ₑ provides for concatenating the resulting image and the initial image frame m to create a concatenated input. Another step 10_{f} provides for feeding the concatenated input into an object detection network configured to detect moving objects. The object detection network is configured to leverage motion-cue side information contained in the resulting image and the initial image frame m to facilitate rapid detection of moving objects in the video.

Method 10 improves object detection capabilities on videos by leveraging motion cues present in the frames surrounding a frame of interest. Though a lack of variation in subsequent frames of a video presents challenges, method 10 uses the similarities between frames to exploit motion and accentuate objects of interest. For example, one embodiment of Method 10 uses frame differencing to identify parts of the image that exhibit motion and leverages this additional side information by combining the differences into a single difference frame, which provides the relevant motion information to perform object detection without increasing the computational requirements. This additional motion information highlights areas of motion that enhance the capability of the object detection network to detect objects better than traditional systems using only a single frame. Suitable examples of the object detection network that may be used include, but are not limited to, a deep neural network, a convolutional neural network (CNN), a region-based CNN (R-CNN), a Fast R-CNN, and a Faster R-CNN, as those networks are understood by those having ordinary skill in the art. Method 10 may use motion cues from a given set of frames that includes a frame of interest, a preceding frame, and a subsequent frame to encapsulate relevant motion information of the given set of frames into a single additional input to the deep neural network. Motion cues may be derived by combining the information present in the frames surrounding a frame of interest (e.g., the preceding frame and the subsequent frame). The deep neural network may be configured to perform repeated convolutions to identify moving objects only in a potential detection region of the initial image frame m that is highlighted in the resulting image. In one embodiment of method 10, the concatenated input at time t only contains one video frame (mₜ) and the resulting image with combined frame differences from either side of the t-th frame (mₜ+n and mₜ−p). The manner of combining differences is explained in greater detail below.

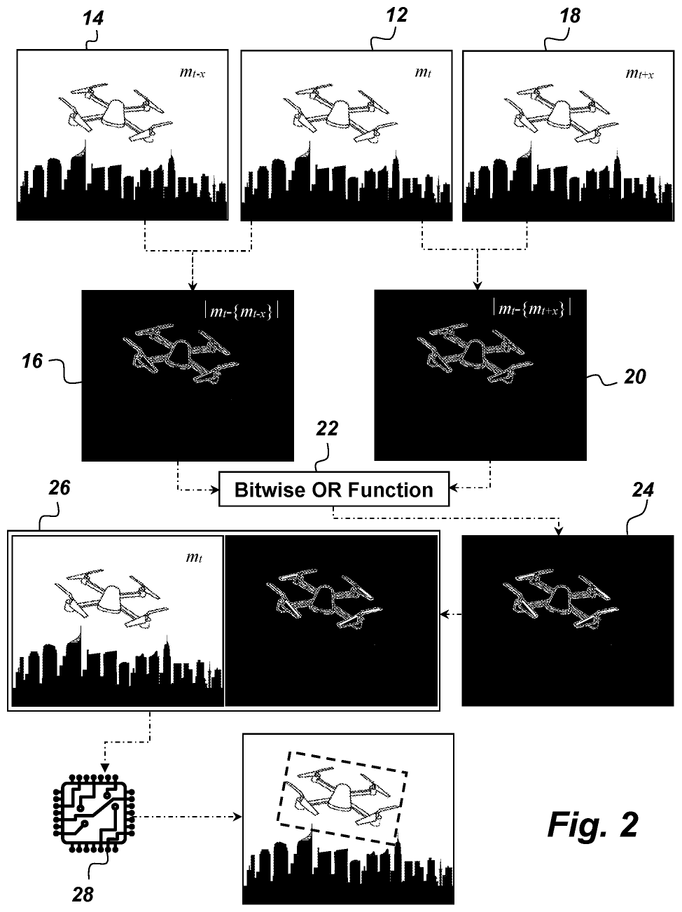

FIG. 2 is a visual representation of an embodiment of method 10 that takes the absolute difference of an initial image frame 12 (at time t) and a previous image frame 14 (frame mₜ−p) to create a first difference image 16. As shown, method 10 also calculates the absolute difference between the initial image frame 12 and a subsequent image frame 18 (frame mₜ+n), which results in a second difference image 20. The first and second difference images 16 and 20 depict pixels where the intensity has changed from one image to another and thus highlights objects that have moved. The first and second difference images 16 and 20 can be combined with different logical operators to obtain motion information. For example, in FIG. 2, the first and second difference images 16 and 20 are combined with a bitwise OR gate function 22 to create the resulting image 24. Alternatively, the bitwise AND function may be used to combine the first and second difference images 16 and 20. The OR function will incorporate more pixels into the potential detection region, but will ultimately make edges of the objects of interest less sharp. The resulting image 24 has the same pixel width and height as the initial image frame 12.

Still referring to FIG. 2, the resulting image 24 is then concatenated with the initial image frame 12 to create the concatenated input 26. The bitwise AND and bitwise OR functions are two suitable operations for combining the m+1 differences that one obtains by differencing the initial image frame 12 with its neighbors separated by n frames on either side of the initial image frame 12. The AND gate was shown to work better for larger objects while the OR gate was better suited for smaller and medium sized objects. An object is determined to be large, medium, or small depending on the size of the bounding box that surrounds the object as described in greater detail below. The initial image frame 12 along with its resulting image (i.e., concatenated input 26) may then be fed into an object detection network 28 where the moving objects may be detected/identified in the potential detection region.

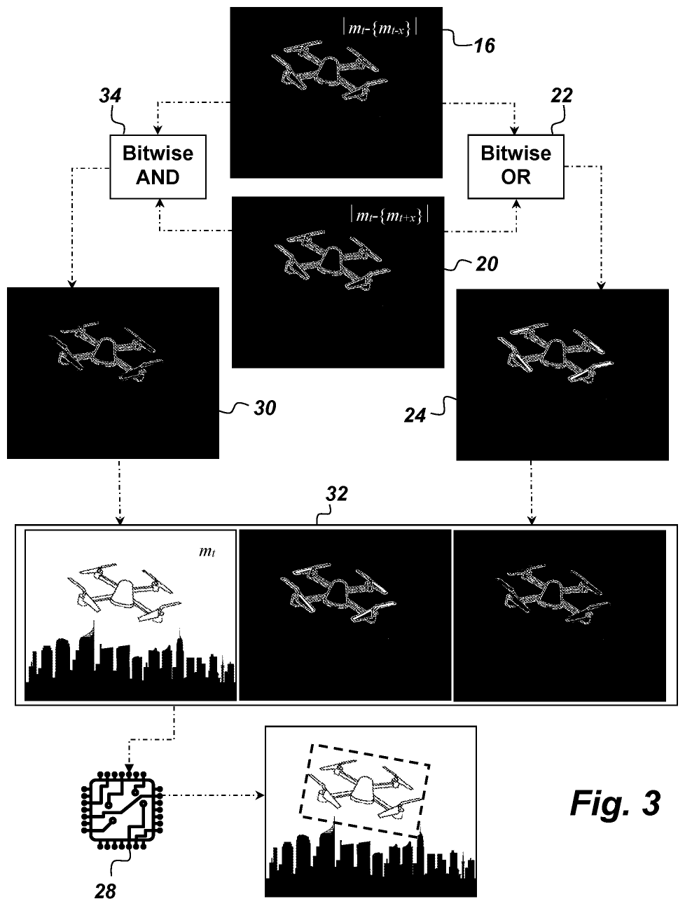

FIG. 3 is a visual representation of another embodiment of method 10 having a concatenated input 32 that comprises the initial image frame 12 and both the AND and the OR gate resulting images. This embodiment of method 10 may bring the advantages of both of these combination schemes (i.e., OR and AND combinations) into a single system. In other words, in addition to the resulting image 24 from the bitwise OR function 22, one may also use a bitwise AND gate 34 to combine the first and second difference images 16 and 20 to create a second resulting image 30. Then, one may concatenate both the resulting image 24 and the second resulting image 30 with the initial image frame 12 to create the concatenated input 32.

If the video exceeds a noise level threshold, a Guassian filter may optionally be applied to the initial image frame m, the previous image frame m-p, and the subsequent image frame m+n prior to the creation of the difference images. Some embodiments of method 10 may further comprise the step of correcting for video camera motion by using motion information metadata. Just like detection in images, video object detection benefits from a localization and classification element. In addition to localization and classification elements, detection of objects in videos also deals with a temporal aspect. Typical issues presented by video data include motion blur from fast-moving objects (which exacerbates feature extraction issues), non-canonical views of an object, and extreme variations in size and position of objects over time. In terms of training a deep neural network, yet another unique issue to video object detection is the lack of variation in features and scenery from frame to frame. These videos can have limited data distributions and as a result, networks trained on video stills can be especially prone to overfitting. Method 10 exploits the similarity in images because video data captures a temporal element that single, varied images do not have. Based on a classification of the frame quality, the number of frames used and their features can be adjusted up or down. Though more frames could be used in method 10, the embodiments discussed herein only aggregate features using the three-frame method, employing frames in the immediate vicinity of the key frame.

Method 10 was tested on a dataset that consisted of many different videos that feature multiple kinds of aerial unmanned vehicles (UAVs) including a Matrice, a Phantom, a fixed-wing drone, a Parrot, and an Inspire UAV. For this test, we parsed the videos into frames and chose one in every twenty frames as a key frame of interest. When using the frame diffing methods, we called on the frames surrounding those key images to use in the signal processing procedures. Camera motion produces more pixels in a resulting frame-diff image than videos taken from a stationary camera. Due to this, we conducted experiments on three different subsets of the dataset. First, we used all of the data combined to account for a wider range of video collection methods. Then, we manually checked each video for moving and static cameras. The corresponding videos for each were split into two more subsets: videos where the camera moves (a.k.a motion) and those where the camera is static (a.k.a stationary). Differentiating between these two sets of data allowed us to better analyze how motion affects the frame-differenced image features extracted by Faster R-CNN since camera motion accentuates more pixels in the subtracted frames.

An embodiment of method 10 may be described as comprising two parts: (1) using three-frame differencing to extract motion features from the frames surrounding the image of interest; and (2) feeding those motion features into an object detection network at train and test time. The following is a description of an example way an object detection network may be trained. In this example, we used the two-stage Faster R-CNN detector with a residual convolutional neural network that is 50 layers deep (ResNet50 residual network) and a Feature Pyramid Network backbone. Training weights were initialized using a ResNet50 model pretrained on a large-scale hierarchical image database, and the network was end-to-end fine-tuned allowing all layers and the ResNet50 stem to be trained. The training process was implemented using a library which allowed customization of network inputs with more than three channels. Then, to explore how the extracted motion saliency affects detection, we constructed three signal processing trials per bitwise function which we compare to the baselines. A baseline was obtained for each dataset by simply training on only the three-channel red-green-blue (RGB) data inputs from key frames, without any additional motion information. For the first trial, each target image at time t was converted to gray scale and the three-channel bitwise image was appended to that original gray scale image creating a four-channel input. This was named the “Grayscale frame and three-channel diff.” Next, another process was done where the three-channel bitwise image was converted to a one-channel gray scale array and appended to the three-channel RGB target image. This resulted in another four-channel input, called “RGB image and one-channel diff.” For the last trial, we combined all information from all channels and created a six-channel input—which includes the three-channel bitwise image appended to the three-channel RGB target image, creating an “RGB image and three-channel diff.” These trials were completed for each signal processing function (AND and OR) for the three datasets (stationary, motion, and all data).

Below, we show our experimental results in three separate tables corresponding to the three datasets outlined above (i.e., the complete dataset, the dataset of stationary cameras, and the dataset of cameras that move). Table 1 shows the experiment results for all of the test data, including both motion and stationary videos. Table 2 depicts the results from videos where the camera is stationary. Table 3 shows the experiment results from only videos where the camera is in motion. The “Training and Testing Regime” column refers to the concatenation methods mentioned above. The overall average precision (AP) is the mean average precision measured on five percent increments from fifty to ninety-five. AP₅₀ is the average precision measured for objects that meet or exceed a fifty-percent intersection over union. AP₇₅ is measured for detections at or above seventy-five percent intersection over union. AP_{S}, AP_{M}, and AP_{L} respectively refer to the overall average precision for small, medium, and large objects. Any bounding box under 32×32 pixels is considered small, large boxes are larger than 96×96 pixels, and medium boxes fall between those two sizes.

TABLE 1
All Videos

| Bitwise Function | Training and Testing Regime | AP | AP₅₀ | AP₇₅ | AP_{S} | AP_{M} | AP_{L} |
|---|---|---|---|---|---|---|---|
| None | Baseline | 38.01 | 86.16 | 25.17 | 31.97 | 48.41 | 57.13 |
| AND signal | Grayscale frame and 3-channel diff | 39.83 | 83.96 | 31.37 | 35.01 | 49.98 | 68.28 |
| | RGB image and 1-channel diff | 39.95 | 83.87 | 32.98 | 34.82 | 51.28 | 60.79 |
| | RGB image and 3-channel diff | 39.22 | 82.12 | 32.25 | 32.50 | 50.81 | 66.70 |
| OR signal | Grayscale frame and 3-channel diff | 30.13 | 73.23 | 17.87 | 22.74 | 40.14 | 65.00 |
| | RGB image and 1-channel diff | 35.96 | 80.95 | 25.01 | 29.40 | 45.88 | 61.61 |
| | RGB image and 3-channel diff | 39.42 | 85.45 | 31.31 | 33.25 | 48.40 | 66.95 |

TABLE 2
Stationary Videos

| Bitwise Function | Training and Testing Regime | AP | AP₅₀ | AP₇₅ | AP_{S} | AP_{M} | AP_{L} |
|---|---|---|---|---|---|---|---|
| None | Baseline | 42.36 | 84.08 | 38.08 | 33.71 | 50.19 | 66.47 |
| AND signal | Grayscale frame and 3-channel diff | 53.47 | 86.78 | 62.35 | 42.92 | 65.37 | 74.18 |
| | RGB image and 1-channel diff | 46.79 | 81.17 | 49.32 | 40.67 | 59.62 | 69.31 |
| | RGB image and 3-channel diff | 52.82 | 87.13 | 60.28 | 42.85 | 64.92 | 70.20 |
| OR signal | Grayscale frame and 3-channel diff | 46.03 | 83.76 | 45.64 | 37.09 | 55.05 | 69.63 |
| | RGB image and 1-channel diff | 39.40 | 73.42 | 38.30 | 31.10 | 54.64 | 56.43 |
| | RGB image and 3-channel diff | 49.74 | 88.16 | 50.55 | 38.00 | 59.87 | 71.19 |

TABLE 3
Motion Videos

| Bitwise Function | Training and Testing Regime | AP | AP₅₀ | AP₇₅ | AP_{S} | AP_{M} | AP_{L} |
|---|---|---|---|---|---|---|---|
| None | Baseline | 38.13 | 90.15 | 24.21 | 33.61 | 46.16 | N/A |
| AND signal | Grayscale frame and 3-channel diff | 36.04 | 86.71 | 20.92 | 31.77 | 44.49 | N/A |
| | RGB image and 1-channel diff | 37.87 | 87.91 | 22.86 | 33.37 | 47.05 | N/A |
| | RGB image and 3-channel diff | 38.41 | 89.01 | 24.51 | 33.64 | 47.97 | N/A |
| OR signal | Grayscale frame and 3-channel diff | 25.37 | 70.01 | 10.11 | 20.80 | 33.30 | N/A |
| | RGB image and 1-channel diff | 38.66 | 89.28 | 25.72 | 33.81 | 47.28 | N/A |
| | RGB image and 3-channel diff | 38.99 | 90.86 | 24.65 | 35.72 | 45.60 | N/A |

From the results of our test/experiment, we concluded that the filters in the Faster R-CNN network benefit from sharper edges and more distinct features when the camera is stationary. However, we do see that using the bitwise-OR when the camera moves can make some improvements over the baseline. If an object of interest moves while the camera is still, the same-ness of pixels from one frame to another will mask all non-moving objects in the scene. Thus, method 10 highlights the features of anything that moves within the field of view. At the same time, even if the camera moves (e.g. if a camera pans or zooms in on an object) using motion saliency gained from frame-diffing still presents the detector with discernible edges and features that are learnable. If a camera moves, or if other objects in the frame move (e.g. if leaves or clouds move) the difference images retain extra features that aren't pertinent to the object of interest. Regardless of the noise though, we see that the object detector is still able to parse the noisy motion image, especially when the original RGB features from the key frame are retained in the input. Since the extra pixels appear due to camera motion, our network is able to use that information in conjunction with the original, key-frame RGB image.

In terms of signal concatenation, there are three primary tests that show the possibilities of exploiting motion saliency. Each progressive test demonstrates the affect that frame diffing can have when used with the original image. Our first test was the gray scale image concatenated with the three-channel differenced features. While the All Videos results in Table 1 used with the AND signal scored the best for most metrics, further insight into this concatenation is gained from the stationary results in Table 2. When the camera is stationary, the grayscale image and three-channel difference method combined using the bitwise-AND had the best results for the overall AP-11% higher than the baseline. That result is due in large part to the increased accuracy of the bounding box predictions, as evidenced by the AP₇₅ score, which gained 24% over the stationary baseline. When the camera is stationary, the bitwise-AND provides sharp edge features of moving objects. So, the features from this frame-diff method appear to provide more insight as to the location of the object of interest than the RGB information from the original key frame image. Even with an OR signal, the gray scale image with the three-channel difference still performs better than the baseline given a stationary camera with about 4% gains made in overall AP. Unfortunately, this form of concatenation does not work as well as the baseline when the camera moves, resulting in the lowest scores across all metrics in Table 3.

The second concatenation option converted the frame-diff into a single-channel image that is concatenated onto the original RGB image. In Table 3, we see that this method performs incrementally better (by 1.5%) than the previous four-channel trial when the bitwise-OR is used on all data which includes camera motion. In the experiments using all videos (Table 1), this method was able to achieve a 7% gain over the baseline for AP₇₅ when combined with the AND signal, demonstrating how that network achieved better accuracy of bounding box proposals. Notable in Table 2, the RGB and one-channel frame difference had a performance dip on stationary videos for both bitwise functions compared to the other concatenation methods. This is likely because, when the camera does not move, the three channel frame-differenced concatenations contain more information that the network can use. Thus, converting these three-channels into a single-channel threw out important information that the networks trained on stationary videos use to boost performance.

For the third concatenation method, the three-channel frame differenced image was concatenated onto the RGB image resulting in a six-channel input. This trial retains the most information from the original key frame and the frame differenced image. As depicted in Table 3, this method provides the best detections (especially when using the OR signal) compared to the baseline if a camera is likely to move at all relative to the scene. This method consistently performed better than the baseline for overall AP. In Table 1, our trials for all videos in conjunction with the OR signal also show promise that this six-channel method helps boost detections of small and large objects when compared to the baseline.

As shown in FIG. 3, the bitwise AND function combines the two differenced frames in such a way that it only retains pixels from objects that have moved in the key frame. Meanwhile the bitwise OR operation results in an image that has a ghosting effect where motion from frames mₜ−p, mₜ, and mₜ+n are all retained in the concatenated input. From the results conveyed in Table 2, the AND function clearly performs the best when the camera collecting the videos is stationary. All values in that section have shown an improvement over the baseline. This is because the information from motion saliency tends to contain almost exclusively the object of interest which moves relative to the camera. Interestingly, the OR function in our trials performed better than the AND function for almost all metrics when the camera moved (shown in Table 3). As expected, the motion from the camera means that the frame-difference contains more highlighted pixels. Photos showing such highlighted pixels can be seen in the paper “Leveraging motion saliency via frame differencing for enhanced object detection in videos” by Lena Nans et al. in Proc. SPIE 12527, Pattern Recognition and Tracking XXXIV, 125270V (13 Jun. 2023), which paper is incorporated by reference herein.

When that difference information in the resulting image(s) is combined with the RGB key frame information, the networks are able to extract more information which helps in detecting objects of interest. When implementing this processing step, it would be beneficial to account for the inherent latency in using a frame from t−1, t−2, or t−x frames. For example, if a camera's frame rate is thirty frames per second, and if one wants to use the frames surrounding a frame of interest, then there would be at least a 1/30th second delay in this algorithm (plus the processing needed at inference time). One can adjust the number of frames n (or the time x) between the initial frame of interest and the preceding and subsequent frames to ensure that motion cues are captured by taking into account one or more of the frame rate of the video and the expected speed of a moving object in the video. Given our results from the stationary vs motion trials, the best applications for this time delay approach would be for stationary cameras since those would produce less motion signal noise.

In some embodiments, the signal processing step may include incorporating ego-motion to compensate for camera motion. By matching the pixels between frames to a fiduciary point, we would be able to sift out the camera motion from the object of interest. This added step would thereby provide a means to ignore the motion noise generated by the camera's motion. Experimenting with noise reduction, thresholds, and background modeling may also help weed out extraneous frame-differenced pixels, which would be especially useful for videos with camera motion. Furthermore, feature extraction using motion saliency can be used in tracking algorithms. By selecting key-frames, this detection method can reinforce existing tracks to make them more accurate and precise.

From the above description of the method 10 for detecting objects in video, it is manifest that various techniques may be used for implementing the concepts of method 10 without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that method 10 is not limited to the particular embodiments described herein, but is capable of many embodiments without departing from the scope of the claims.

We claim:

1. A method for detecting objects in a video comprising:
selecting an initial image frame m from the video, wherein the initial image frame m is preceded by a previous image frame m−p and followed by a subsequent image frame m+n, where n and p represent a number of frames;
creating a first difference image by subtracting the subsequent image frame min from the initial image frame m;
creating a second difference image by subtracting the initial image frame m from the previous image frame m−p;
combining the first and second difference images to create a resulting image;
concatenating the resulting image and the initial image frame m to create a concatenated input;
feeding the concatenated input into an object detection network; and
wherein the object detection network is configured to leverage motion-cue side information contained in the resulting image and the initial image frame m to facilitate rapid detection of moving objects in the video.

2. The object detection method of claim 1, wherein the combining step comprises using a bitwise OR gate to create the resulting image.

3. The object detection method of claim 1, wherein the combining step comprises using a bitwise AND gate to create the resulting image.

4. The object detection method of claim 2, further comprising:
using a bitwise AND gate to combine the first and second difference images to create a second resulting image; and
wherein the concatenating step comprises concatenating both the resulting image and the second resulting image with the initial image frame m to create the concatenated input.

5. The object detection method of claim 1, wherein the object detection network is a deep neural network.

6. The object detection method of claim 5, wherein the deep neural network is a two-stage region-based computational neural network.

7. The object detection method of claim 5, wherein the deep neural network is configured to perform repeated convolutions to identify moving objects only in portions of the initial image frame m that are highlighted in the resulting image.

8. The object detection method of claim 4, further comprising applying a Guassian filter to the initial image frame m, the previous image frame m-p, and the subsequent image frame m+n prior to the creating steps if the video exceeds a noise level threshold.

9. The object detection method of claim 8, further comprising correcting for video camera motion by using motion information metadata.

10. A method for detecting objects in a video comprising:
parsing the video into frames;
selecting one in every predetermined quantity of frames as a key frame of interest m;
calculating the absolute difference between a given key frame of interest mₜ at time t and a preceding frame mₜ₋ₓ according to abs (mₜ−mₜ₋ₓ) to create a first difference image, where x is a predetermined amount of time;
calculating the absolute difference between the given key frame of interest mₜ and a subsequent frame mₜ₊ₓ according to abs (mₜ−mₜ₊ₓ) to create a second difference image;
performing a bitwise OR function on the first and second difference images to create a first resulting image;
feeding the first resulting image and the given key frame of interest mₜ into a deep neural network configured to detect moving objects in the video.

11. The method of claim 10, further comprising performing a bitwise AND function on the first and second difference images to create a second resulting image; and
wherein the feeding step further comprises feeding the second resulting image into the deep neural network configured to detect moving objects in the video.

12. The method of claim 11, further comprising adjusting x so as to account for an inherent frame-rate latency of a camera that recorded the video and an expected speed of a given moving object.

13. The method of claim 12, further comprising incorporating ego-motion to compensate for camera motion by matching pixels between the given key frame of interest and the preceding and subsequent frames to a fiduciary point so as to ignore motion noise generated by the camera's motion.

14. A method for detecting objects in a video taken by a camera comprising:
extracting motion information from the video by subtracting a frame of interest from its associated adjacent frames to create two initial difference images;
using one or more of a bitwise-AND function and a bitwise-OR function to create a resulting image from the two initial difference images, wherein the resulting image retains past and future motion information relative to the frame of interest;
concatenating the resulting image onto the frame of interest; and
feeding the concatenated images into a deep neural network configured to identify moving objects in the frame of interest.

15. The method of claim 14, wherein if the camera is stationary relative to its surroundings, the bitwise-AND function is used to create the resulting image.

16. The method of claim 15, wherein if the camera was moving relative to its surroundings when the video was taken, the bitwise-OR function is used to create the resulting image.

17. The method of claim 14, wherein both the bitwise-AND and the bitwise-OR functions are used to create two resulting images that are both concatenated onto the frame of interest prior to being fed into the deep neural network.

18. The method of claim 14, wherein the deep neural network is a Faster R-CNN.

19. The method of claim 15, further comprising applying a Guassian filter to the frame of interest and to the two initial difference images prior to creating the resulting image if the video exceeds a noise level threshold.

20. The method of claim 19, further comprising adding a time delay between the frame of interest and the two initial difference images so as to account for an inherent frame-rate latency of the camera.
